(19) United States
(12) Patent Application Publication
(10) Pub. No.: US 2023/0376832 A1
(43) Pub. Date: Nov. 23, 2023

(54) CALIBRATING PARAMETERS WITHIN A VIRTUAL ENVIRONMENT USING REINFORCEMENT LEARNING

(71) Applicant: GM Global Technology Operations LLC, Detroit, MI (US)

(72) Inventors: Alireza Esna Ashari Esfahani, Novi, MI (US); Sayyed Rouhollah Jafari Tafti, Troy, MI (US)

(21) Appl. No.: 17/747,243

(22) Filed: May 18, 2022

(51) Int. Cl. G06N 20/00

(52) U.S. Cl. CPC G06N 20/00

(57) ABSTRACT

A system is disclosed that includes a computer including a processor and a memory. The memory including instructions such that the processor is programmed to: generate a simulated environment, the simulated environment representing a plurality of driving situations, and generate, via a reinforcement learning agent, at least one calibration parameter based on simulated vehicle operations within a simulated environment.

### INTRODUCTION

The present disclosure relates to using a reinforcement learning agent to calibrate one or more vehicle parameters within a virtual environment.

Reinforcement learning systems include an agent that interacts with an environment by performing actions that are selected by the reinforcement learning system in response to receiving observations that characterize the current state of the environment.

### SUMMARY

A system is disclosed that includes a computer including a processor and a memory. The memory including instructions such that the processor is programmed to: generate a simulated environment, the simulated environment representing a plurality of driving situations, and generate, via a reinforcement learning agent, at least one calibration parameter based on simulated vehicle operations within a simulated environment.

In other features, the processor is further programmed to generate reinforcement learning agent for each zone within an operation state space, wherein each zone corresponds to a set of calibration parameters.

In other features, the processor is further programmed to divide the operation state space into at least two adjacent operation state space zones when the reinforcement learning agent has not converged.

In other features, each reinforcement learning agent trains for at least one of a predetermined computation budget or a predetermined time budget.

In other features, the processor is further programmed to generate a supervisor reinforcement learning agent that is configured to manage transitions between at least two adjacent operation state space zones.

In other features, the supervisor reinforcement learning agent generates a transition set of calibration parameters based on the adjacent zones.

In other features, the supervisor reinforcement learning agent generates the transition calibration parameter according to w=a₁w₁+a₂w₂+ . . . a_{N}w_{N}, where aᵢ represents an i-th coefficient generated by the supervisor reinforcement learning agent, wᵢ represents an output of the i-th reinforcement learning agent, and N represents a number of adjacent zones.

In other features, the processor is further programmed to generate the simulated environment based on a desired simulated driving situation.

A system is disclosed that includes a computer including a processor and a memory. The memory including instructions such that the processor is programmed to: receive collected vehicle state parameters from a vehicle, determine whether a reported problem corresponding to the collected vehicle state parameters are below a predetermined frequency threshold, and retrain at least one reinforcement learning agent within a constructed simulated driving scenario based on the collected vehicle state parameters.

In other features, the processor is further programmed to determine whether the reported problem affects a number of vehicles that exceeds a predetermined vehicle amount.

In other features, the processor is further programmed to generate an alert when the reported problem affects a number of vehicles that exceeds the predetermined vehicle amount.

In other features, the alert comprises at least one of an audio alert, a haptic alert, or a visual alert.

A method is disclosed that includes generating a simulated environment, the simulated environment representing a plurality of driving situations, and generating, via a reinforcement learning agent, at least one calibration parameter based on simulated vehicle operations within a simulated environment.

In other features, the method includes generating reinforcement learning agent for each zone within an operation state space, wherein each zone corresponds to a set of calibration parameters.

In other features, the method includes dividing the operation state space into at least two adjacent operation state space zones when the reinforcement learning agent has not converged.

In other features, each reinforcement learning agent trains for at least one of a predetermined computation budget or a predetermined time budget.

In other features, the method includes generating a supervisor reinforcement learning agent that is configured to manage transitions between at least two adjacent operation state space zones.

In other features, the supervisor reinforcement learning agent generates a transition set of calibration parameters based on the adjacent zones.

In other features, the supervisor reinforcement learning agent generates the transition calibration parameter according to w=a₁w₁+a₂w₂+ . . . a_{N}w_{N}, where aᵢ represents an i-th coefficient generated by the supervisor reinforcement learning agent, wᵢ represents an output of the i-th reinforcement learning agent, and N represents a number of adjacent zones.

In other features, the method includes generating the simulated environment based on a desired simulated driving situation.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a block diagram of an example system including a vehicle;

FIG. 2 is a block diagram of an example server within the system;

FIG. 3 is a block diagram of an example computing device;

FIG. 4 is a diagram of an example neural network;

FIG. 5 is a diagram illustrating an example state space including multiple zones generated by one or more reinforcement learning agents;

FIG. 6 is a diagram illustrating a supervisor reinforcement learning agent that calculates a transition calibration parameter using two adjacent zones;

FIG. 7 is a flow diagram illustrating an example process for using RL agents to generate calibration parameters; and

FIG. 8 is a flow diagram illustrating an example process for monitoring calibration parameters after vehicle deployment.

### DETAILED DESCRIPTION

The following description is merely exemplary in nature and is not intended to limit the present disclosure, application, or uses.

Reinforcement Learning (RL) is a form of goal-directed machine learning. For example, an agent can learn from direct interaction with its environment without relying on explicit supervision and/or complete models of the environment. Reinforcement learning is a framework modeling the interaction between a learning agent and its environment in terms of reinforcement learning states, actions, and rewards.

At each time step, an agent receives a RL state, selects an action based on a policy, receives a scalar reward, and transitions to the next RL state. The state can be based on one or more sensor inputs indicative of the environmental data. The agent's goal is to maximize an expected cumulative reward. The agent may receive a positive scalar reward for a positive action and a negative scalar reward for a negative action. Thus, the agent “learns” by attempting to maximize the expected cumulative reward. While the agent is described within the context of a vehicle herein, it is understood that the agent may comprise any suitable reinforcement learning agent.

As discussed in greater detail herein, a vehicle may include one or more reinforcement learning agents. Each reinforcement learning agent is trained to generate output representing a tuning calibration parameter for a vehicle based on an observations of the reinforcement learning agents within a simulated environment. For example, during operation, different simulated driving environments can be selected to represent one or more driving conditions. Sensor data and ground truth can be generated for each different driving condition, and the sensor data for each different driving condition is provided to an autonomous vehicle algorithm.

Within the present disclosure, operation state space refers to parameters in which any change in the corresponding parameter may drastically change behavior of the system. Thus, operation state space may be referred to as state space, or vice versa. The operation state space can be equal to RL states, a subset of RL states, and/or a combination of at least some of the RL states and other system parameters.

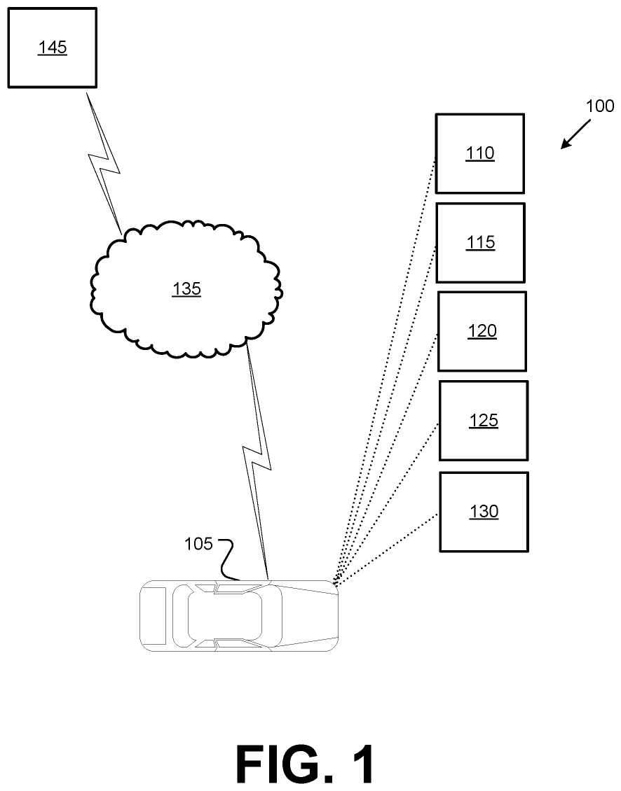

FIG. 1 is a block diagram of an example vehicle system 100. The system 100 includes a vehicle 105, which can comprise a land vehicle such as a car, truck, etc., an aerial vehicle, and/or an aquatic vehicle. The vehicle 105 includes a computer 110, vehicle sensors 115, actuators 120 to actuate various vehicle components 125, and a vehicle communications module 130. Via a network 135, the communications module 130 allows the computer 110 to communicate with a server 145.

The computer 110 may operate a vehicle 105 in an autonomous, a semi-autonomous mode, or a non-autonomous (manual) mode. For purposes of this disclosure, an autonomous mode is defined as one in which each of vehicle 105 propulsion, braking, and steering are controlled by the computer 110; in a semi-autonomous mode the computer 110 controls one or two of vehicles 105 propulsion, braking, and steering; in a non-autonomous mode a human operator controls each of vehicle 105 propulsion, braking, and steering.

The computer 110 may include programming to operate one or more of vehicle 105 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via the vehicle 105 communications module 130 as described further below, more than one processor, e.g., included in electronic controller units (ECUs) or the like included in the vehicle 105 for monitoring and/or controlling various vehicle components 125, e.g., a powertrain controller, a brake controller, a steering controller, etc. Further, the computer 110 may communicate, via the vehicle 105 communications module 130, with a navigation system that uses the Global Position System (GPS). As an example, the computer 110 may request and receive location data of the vehicle 105. The location data may be in a known form, e.g., geo-coordinates (latitudinal and longitudinal coordinates).

The computer 110 is generally arranged for communications on the vehicle 105 communications module 130 and also with a vehicle 105 internal wired and/or wireless network, e.g., a bus or the like in the vehicle 105 such as a controller area network (CAN) or the like, and/or other wired and/or wireless mechanisms.

Via the vehicle 105 communications network, the computer 110 may transmit messages to various devices in the vehicle 105 and/or receive messages from the various devices, e.g., vehicle sensors 115, actuators 120, vehicle components 125, a human machine interface (HMI), etc. Alternatively or additionally, in cases where the computer 110 actually comprises a plurality of devices, the vehicle 105 communications network may be used for communications between devices represented as the computer 110 in this disclosure. Further, as mentioned below, various controllers and/or vehicle sensors 115 may provide data to the computer 110. The vehicle 105 communications network can include one or more gateway modules that provide interoperability between various networks and devices within the vehicle 105, such as protocol translators, impedance matchers, rate converters, and the like.

Vehicle sensors 115 may include a variety of devices such as are known to provide data to the computer 110. For example, the vehicle sensors 115 may include Light Detection and Ranging (lidar) sensor(s) 115, etc., disposed on a top of the vehicle 105, behind a vehicle 105 front windshield, around the vehicle 105, etc., that provide relative locations, sizes, and shapes of objects and/or conditions surrounding the vehicle 105. As another example, one or more radar sensors 115 fixed to vehicle 105 bumpers may provide data to provide and range velocity of objects (possibly including second vehicles 106), etc., relative to the location of the vehicle 105. The vehicle sensors 115 may further include camera sensor(s) 115, e.g., front view, side view, rear view, etc., providing images from a field of view inside and/or outside the vehicle 105.

The vehicle 105 actuators 120 are implemented via circuits, chips, motors, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component (as described below), a park assist component, an adaptive cruise control component, an adaptive steering component, a movable seat, etc.

In addition, the computer 110 may be configured for communicating via a vehicle-to-vehicle communication module or interface 130 with devices outside of the vehicle 105, e.g., through a vehicle to vehicle (V2V) or vehicle-to-infrastructure (V2X) wireless communications to another vehicle, to (typically via the network 135) a remote server 145. The module 130 could include one or more mechanisms by which the computer 110 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 130 include cellular, Bluetooth®, IEEE 802.11, dedicated short-range communications (DSRC), and/or wide area networks (WAN), including the Internet, providing data communication services.

The network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short-Range Communications (DSRC), etc.), local area networks (LAN) and/or wide area networks (WAN), including the Internet, providing data communication services.

A computer 110 can receive and analyze data from sensors 115 substantially continuously, periodically, and/or when instructed by a server 145, etc. Further, object classification or identification techniques can be used, e.g., in a computer 110 based on lidar sensor 115, camera sensor 115, etc., data, to identify a type of object, e.g., vehicle, person, rock, pothole, bicycle, motorcycle, etc., as well as physical features of objects.

As described in greater detail herein, the computer 110 is configured to implement a neural network-based reinforcement learning procedure. The computer 110 generates a set of RL state-action values as outputs for an observed input state. The computer 110 can select an action corresponding to a maximum RL state-action value, e.g., the highest RL state-action value. The computer 110 obtains sensor data from the sensors 115 that correspond to an observed input state.

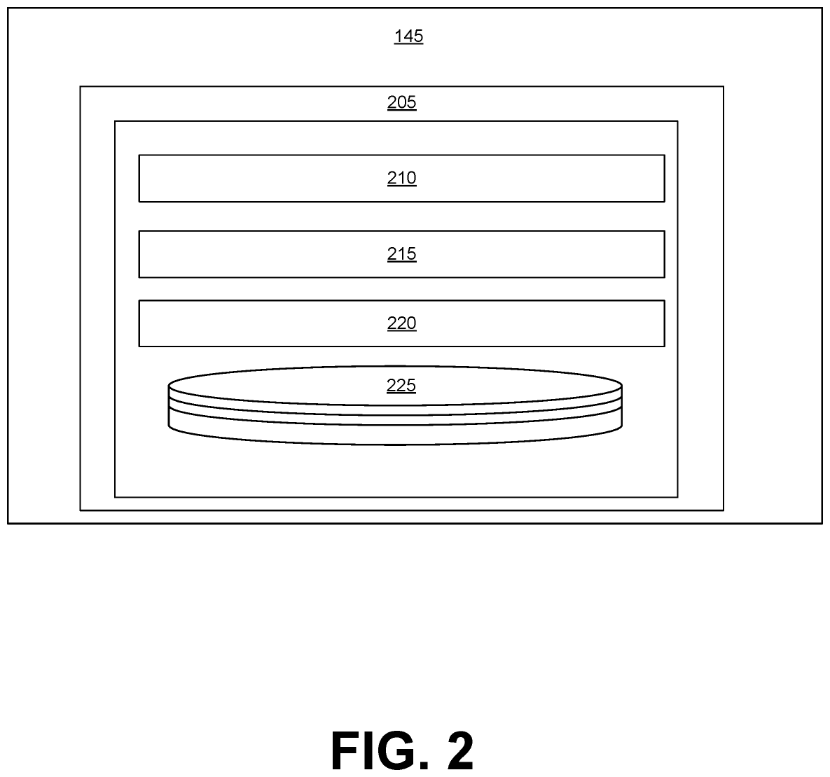

FIG. 2 illustrates an example server 145 that includes a reinforcement learning (RL) system 205. As shown, the RL system 205 may include a reinforcement learning (RL) agent module 210, one or more RL agents 215, a simulation environment generation module 220, and a storage module 225.

In particular, the RL agent module 210 can manage, maintain, train, implement, utilize, or communicate with one or more RL agents 215. For example, the RL agent module 210 can communicate with the storage module 225 to access one or more RL agents 215. The RL agent module 210 can also access data specifying a different number of learner policies, which is described in greater detail below.

The simulation environment generation module 220 generates one or more simulated driving situations, e.g., driving environments. The simulation environment generation module 220 can represent a set of varying conditions for a driving scenario under which autonomous vehicle the one or more RL agents 215 determine calibration parameters for the vehicle 105.

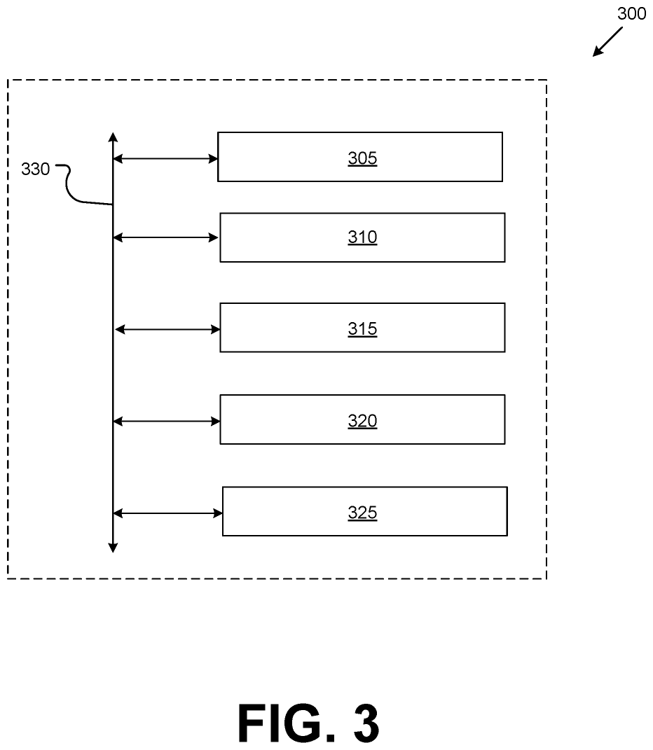

FIG. 3 illustrates an example computing device 300 i.e., computer 110 and/or server(s)145 that may be configured to perform one or more of the processes described herein. As shown, the computing device can comprise a processor 305, memory 310, a storage device 315, an I/O interface 320, and a communication interface 325. Furthermore, the computing device 300 can include an input device such as a touchscreen, mouse, keyboard, etc. In certain implementations, the computing device 300 can include fewer or more components than those shown in FIG. 3.

In particular implementations, processor(s) 305 includes hardware for executing instructions, such as those making up a computer program. As an example, and not by way of limitation, to execute instructions, processor(s) 305 may retrieve (or fetch) the instructions from an internal register, an internal cache, memory 310, or a storage device 315 and decode and execute them.

The computing device 300 includes memory 310, which is coupled to the processor(s) 305. The memory 310 may be used for storing data, metadata, and programs for execution by the processor(s). The memory 310 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 310 may be internal or distributed memory.

The computing device 300 includes a storage device 315 includes storage for storing data or instructions. As an example, and not by way of limitation, storage device 315 can comprise a non-transitory storage medium described above. The storage device 315 may include a hard disk drive (HDD), flash memory, a Universal Serial Bus (USB) drive or a combination of these or other storage devices.

The computing device 300 also includes one or more input or output (“I/O”) devices/interfaces 320, which are provided to allow a user to provide input to (such as user strokes), receive output from, and otherwise transfer data to and from the computing device 300. These I/O devices/interfaces 320 may include a mouse, keypad or a keyboard, a touch screen, camera, optical scanner, network interface, modem, other known I/O devices or a combination of such I/O devices/interfaces 320. The touch screen may be activated with a writing device or a finger.

The I/O devices/interfaces 320 may include one or more devices for presenting output to a user, including, but not limited to, a graphics engine, a display (e.g., a display screen), one or more output drivers (e.g., display drivers), one or more audio speakers, and one or more audio drivers. In certain implementations, devices/interfaces 320 is configured to provide graphical data to a display for presentation to a user. The graphical data may be representative of one or more graphical user interfaces and/or any other graphical content as may serve a particular implementation.

The computing device 300 can further include a communication interface 325. The communication interface 325 can include hardware, software, or both. The communication interface 325 can provide one or more interfaces for communication (such as, for example, packet-based communication) between the computing device and one or more other computing devices 300 or one or more networks. As an example, and not by way of limitation, communication interface 325 may include a network interface controller (NIC) or network adapter for communicating with an Ethernet or other wire-based network or a wireless NIC (WNIC) or wireless adapter for communicating with a wireless network, such as a WI-FI. The computing device 300 can further include a bus 330. The bus 330 can comprise hardware, software, or both that couples components of computing device 300 to each other.

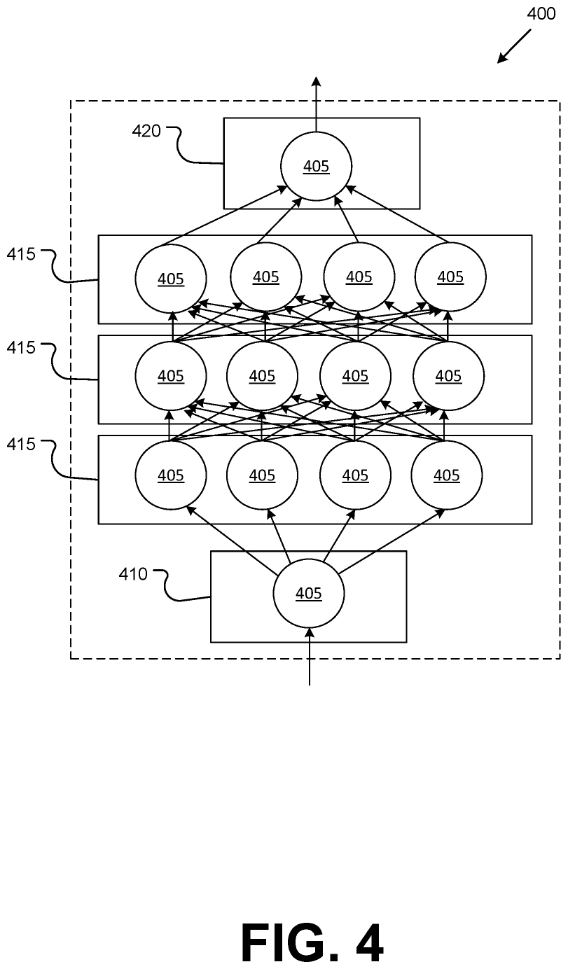

FIG. 4 is a diagram of an example deep neural network (DNN) 400 that may be used herein. Within the present context, the DNN 400 may comprise a single RL agent 215 The DNN 400 includes multiple nodes 405, and the nodes 405 are arranged so that the DNN 400 includes an input layer 410, one or more hidden layers 415, and an output layer 420. Each layer of the DNN 400 can include a plurality of nodes 405. While FIG. 4 illustrates three (3) hidden layers 415, it is understood that the DNN 400 can include additional or fewer hidden layers. The input and output layers 410, 420 may also include more than one (1) node 405.

The nodes 405 are sometimes referred to as artificial neurons, because they are designed to emulate biological, e.g., human, neurons. A set of inputs (represented by the arrows) to each node 405 are each multiplied by respective weights. The weighted inputs can then be summed in an input function to provide, possibly adjusted by a bias, a net input. The net input can then be provided to activation function, which in turn provides a connected node 405 an output. The activation function can be a variety of suitable functions, typically selected based on empirical analysis. As illustrated by the arrows in FIG. 4, node 405 outputs can then be provided for inclusion in a set of inputs to one or more neurons 305 in a next layer.

The DNN 400 can be trained to accept sensor data as input and generate a RL state-action value, e.g., reward value, based on the input. The DNN 400 can be trained with training data, e.g., a known set of sensor inputs, to train the agent for the purposes of determining an optimal policy. In one or more implementations, the DNN 400 is trained via the server 145, and the trained DNN 400 can be transmitted to the vehicle 105 via the network 135. Weights can be initialized by using a Gaussian distribution, for example, and a bias for each neuron 405 can be set to zero. Training the DNN 400 can including updating weights and biases via suitable techniques such as back-propagation with optimizations.

During operation, the computer 110 obtains sensor data from the sensors 115 and provides the data as input to the DNN 400, e.g., the RL agent(s) 215. Once trained, the RL agent 215 can accept the sensor input and provide, as output, one or more RL state-action values based on the sensed input. During execution of the RL agent 215, the state-action values can be generated for each action available to the agent within the environment. In an example implementation, the RL agent 215 is trained according to a baseline policy. The baseline policy can include one or more RL state-action values corresponding to a set of sensor input.

In other words, the RL agent 215 generates output data reflective of one or more calibration parameters. Calibration parameters generated by the RL agents 215 can optimize global metrics such as vehicle fuel consumption, emitted pollution, battery range, and also local metrics such as overshoot, oscillation, response reversal, deviation from reference, delayed response, steady state error, and/or prediction error, as examples. This is done by designing the reward function for the RL agents during training process.

Input data includes, for example, values of a plurality of state variables relating to an environment being explored by the RL agent 215 or a task being performed by the RL agent 215. In some cases, one or more RL state variables may be one-dimensional. In some cases, one or more RL state variables may be multi-dimensional.

A RL state variable may also be referred to as a feature. The mapping of input data to output data may be referred to as a policy, and governs decision-making of the RL agent 215. A policy may, for example, include a probability distribution of particular actions given particular values of state variables at a given time step. Within the present context, the output data comprises vehicle calibration parameters based on the state variables of the simulated environment.

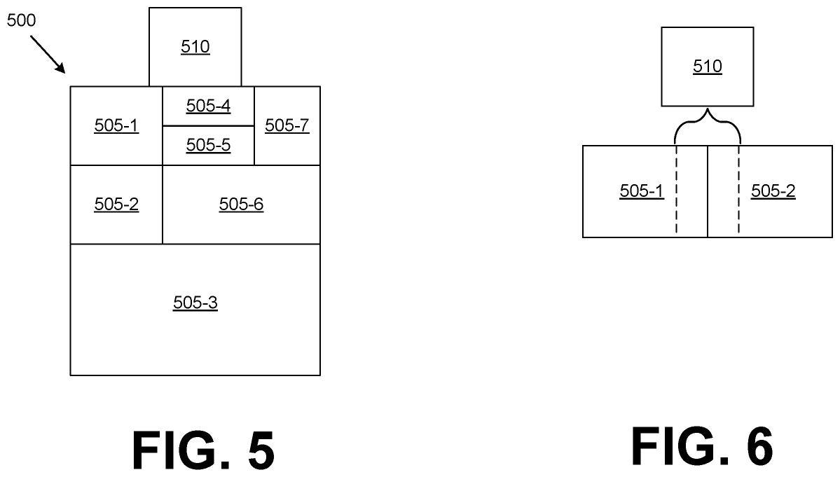

FIG. 5 illustrates an example operation state space 500 that is divided into multiple zones through a calibration process. The state space 500 represents operation parameters computed using the sensor data that represent the driving environment. As shown, the state space 500 includes zones 505-1 through 505-7. Each RL agent 215 trains on a particular state space zone 505-1 through 505-7 for a predetermined computation budget and/or time budget. After the computation budget and/or time budget has been reached, if training has not converged, i.e., reached an optimal configuration, or vehicle performance is less than or equal to a predetermined performance threshold, the RL agent 215 divides the state space zone into two subzones, such as zones 505-1 through 505-7. It is understood that the zones can include more or fewer zones than illustrated in FIG. 5. The zones 505-1 through 505-7 represent state space within two dimensions.

Once a zone is created by the RL agent 215, a new RL agent 215, i.e., a child RL agent 215, is initialized for each zone created. The newly generated RL agent 215 inherits the parameters of the RL agent 215 that generated the particular zone. Once generated, the RL agent 215 trains for the predefined computation budget and/or time budget, which is described in further detail below.

FIGS. 5 and 6 illustrate a supervisor RL agent 510 that manages transitions between various zones 505-1 through 505-7. In an example implementation, once each RL agent 215 has converged and vehicle performance is greater than the predetermined performance, the RL agent module 210 generates the supervisor RL agent 510. The supervisor RL agent 510 is then trained to manage transitions between adjacent zones 505-1 through 505-7. The supervisor RL agent 510 is trained to mitigate parameter jumps when transitioning between zones. The supervisor RL agent 510 can determine a transition calibration parameter w according to:

w=a₁w₁+a₂w₂+ . . . a_{N}w_{N} Eq. 1,

where aᵢ represents an i-th coefficient generated by the supervisor RL agent 510, wᵢ represents the calibration parameters output of the i-th RL agent 210, and N represents the number of adjacent zones. The RL states and reward function for the supervisor RL agent 510 is defined similar to the ones for RL agents 215, as described later, with reward function being revised with additional penalty for jumps in the performance with small changes in state space.

FIG. 6 illustrates example adjacent zones 505-1, 505-2. FIG. 6 also illustrates supervisor RL agent 510 training to mitigate a parameter jump between zones 505-1, 505-2 by calculating a transition calibration parameter w such that there is not an abrupt change between the calibration parameters corresponding to zone 505-1 and the calibration parameter corresponding to zone 505-2.

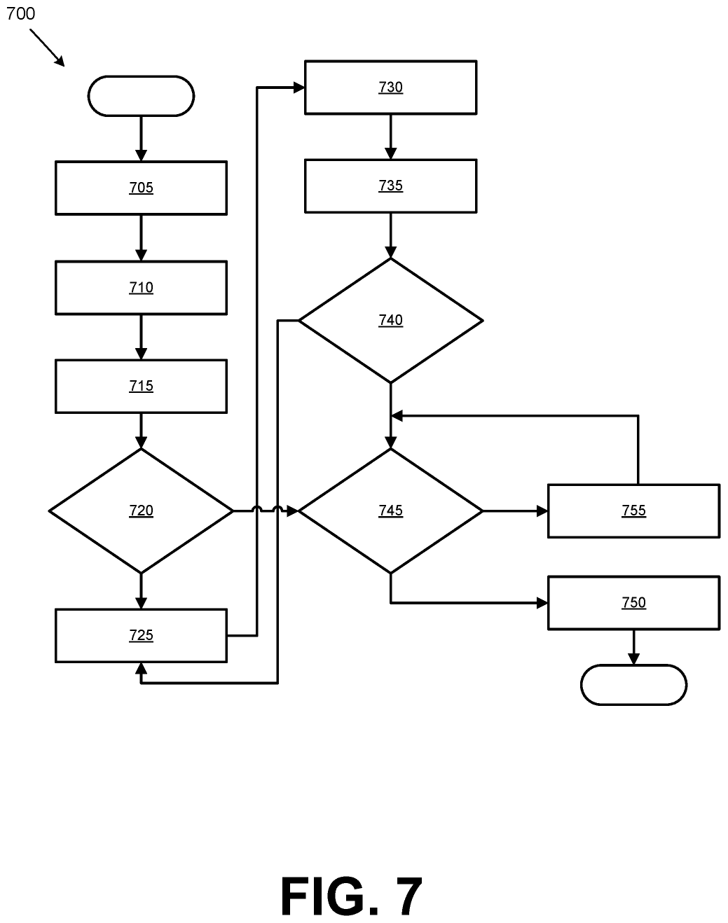

FIG. 7 illustrates an example process 700 for utilizing RL agents 215 to generate calibration parameters. Blocks of the process 700 can be executed by the server 145. At block 705, the simulation environment generation module 220 generates a diverse set of simulated driving situations that is based on variables for defining a plurality of simulated scenarios, i.e., simulated driving scenarios that include simulated weather conditions, i.e., icy road conditions, wet road conditions, simulated traffic congestion, simulated roadway topography, etc. The simulated scenario can also be generated for a specific component of the vehicle, such as engine and battery packs, for which the calibration parameters are to be found by RL agents 215. The virtual environment should be set in a way that it can receive the calibration parameters output from RL agents and generates sensor data which represents the state space.

At block 710, one or more RL agents 215 are generated for tuning calibration parameters via the RL agent module 210. The action space for the RL agents are defined as the tuning calibration parameters and the RL states can consist of process states, inputs, previous outputs and correct system response as some examples. In addition, the reward function includes both global metrics, such as fuel consumption, air pollution and battery range, as well as local metrics such as overshoot, oscillation, response reversal, steady state response, and prediction response.

At block 715, the one or more RL agents 215 are trained according to a baseline policy. The baseline policy can be based on a predetermined computation budget and/or time budget. At block 720, a determination is made whether training has converged and/or vehicle performance based on the generated tuning calibration parameters are greater than a predetermined performance threshold. The predetermined performance threshold can be typically selected based on empirical analysis of a vehicle's performance within a similarly situated environment. If training has converged and the vehicle performance is greater than the predetermined performance threshold, the process 700 transitions to block 745.

If the training has not converged or the vehicle performance is less than or equal to the predetermined performance threshold, the state space is divided into two zones on state space dimension at block 725. At block 730, child RL agents 215 are initialized for each zone. At block 735, each child RL agent 215 trains for the predetermined computation budget and/or the time budget. At block 740, a determination is made whether the training has converged and/or vehicle performance based on the generated tuning calibration parameters are greater than a predetermined performance threshold. If no, the process 700 returns to block 725.

At block 745, a determination is made whether there is more than one zone within the state space. If no, the calibration parameters for the vehicle 105 are confirmed at block 750. Otherwise, at block 755, a supervisor RL agent is generated and trained to manage transitions between adjacent zones. The process 700 then transitions to block 745.

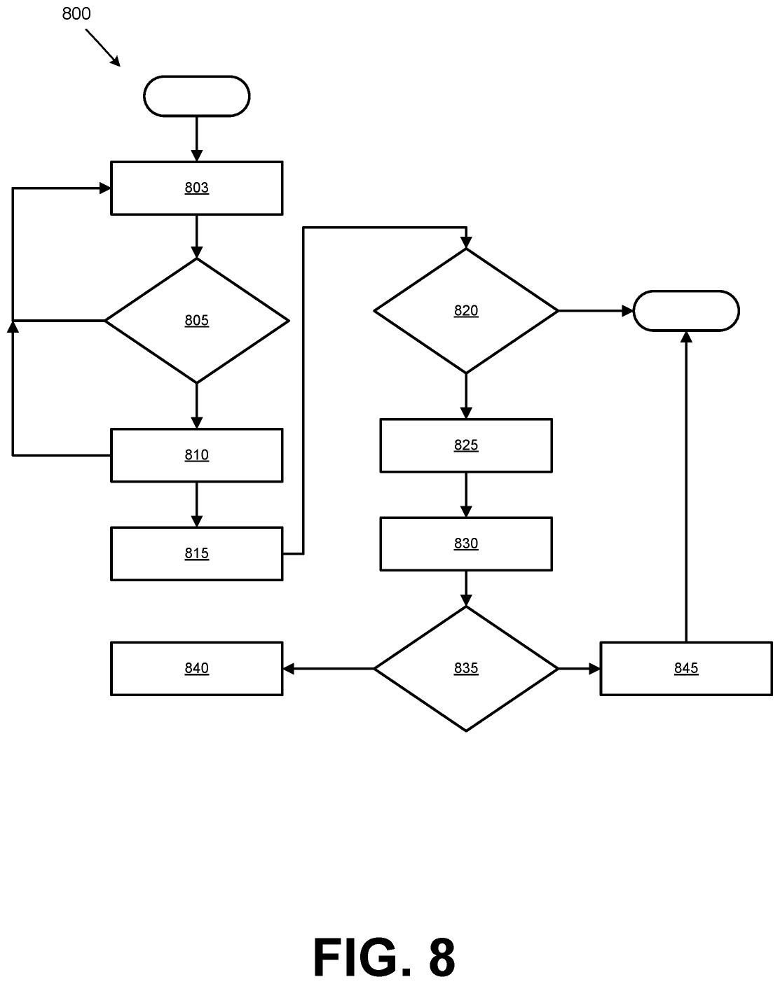

FIG. 8 illustrates an example process 800 for monitoring calibration parameters after vehicle 105 deployment. Blocks of the process 800 can be executed by the computer 110 and/or the server 145. The RL agents 215 can be deployed within the computer 110 such that the RL agents 215 can generate calibration parameters based on an experienced vehicle environment.

At block 803, the vehicle state parameters related to measurable RL agent's reward components are monitored. At block 805, the measurable reward components are compared to predetermined performance thresholds. If the vehicle performance, i.e., measurable reward components, are above the predetermined thresholds, the process 800 returns to block 805. Otherwise, the computer 110 collects one or more vehicle state parameters and transmits the collected parameters to the server 145 at block 810. It is understood that the parameters can be continually monitored at block 803 during vehicle 105 operation.

At block 815, the collected vehicle state parameters are processed and labeled based on a reported problem at the server 145. At block 820, a determination is made by the server 145 whether the reported problem is below a predetermined frequency threshold when compared to the past collected vehicle data in the server 145. If the reported problem corresponding to the collected state parameters are below the predetermined frequency threshold, the process 800 ends.

Otherwise, at block 825, a simulated driving scenario is constructed based on the received vehicle state parameters. At block 830, RL agents 215 corresponding to the collected state parameters are retrained within the constructed simulated driving scenario for updating. At block 835, a determination is made whether reported problem affects a number of vehicles 105 exceeding a predetermined vehicle amount. If no, the process 800 transitions to block 840 in which an alert is generated. The alert can comprise an audio alert, a haptic alert, and/or a visual alert. For example, the computer 110 can generate an alert indicating that the occupant should schedule a dealership visit. In another example, the computer 110 can generate an alert indicating that an over-the-air update is available. In this example, the occupant can provide feedback via an HMI to initialize the over-the-air update. Otherwise, at block 845, the server 145 generates an alert that is transmitted to the vehicle 105 manufacturer for further inspection.

The description of the present disclosure is merely exemplary in nature and variations that do not depart from the gist of the present disclosure are intended to be within the scope of the present disclosure. Such variations are not to be regarded as a departure from the spirit and scope of the present disclosure.

In general, the computing systems and/or devices described may employ any of a number of computer operating systems, including, but by no means limited to, versions and/or varieties of the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer readable medium (also referred to as a processor readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain implementations, and should in no way be construed so as to limit the claims.

Accordingly, it is to be understood that the above description is intended to be illustrative and not restrictive. Many implementations and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future implementations. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system comprising a computer including a processor and a memory, the memory including instructions such that the processor is programmed to:
generate a simulated environment, the simulated environment representing a plurality of driving situations; and
generate, via a reinforcement learning agent, at least one calibration parameter based on simulated vehicle operations within a simulated environment.

2. The system of claim 1, wherein the processor is further programmed to generate reinforcement learning agent for each zone within an operation state space, wherein each zone corresponds to a set of calibration parameters.

3. The system of claim 2, wherein the processor is further programmed to divide the operation state space into at least two adjacent operation state space zones when the reinforcement learning agent has not converged.

4. The system of claim 3, wherein each reinforcement learning agent trains for at least one of a predetermined computation budget or a predetermined time budget.

5. The system of claim 3, the processor is further programmed to generate a supervisor reinforcement learning agent that is configured to manage transitions between at least two adjacent operation state space zones.

6. The system of claim 5, wherein the supervisor reinforcement learning agent generates a transition set of calibration parameters based on the adjacent zones.

7. The system of claim 6, wherein the supervisor reinforcement learning agent generates the transition calibration parameter according to w=a₁w₁+a₂w₂+ . . . a_{N}w_{N}, where aᵢ represents an i-th coefficient generated by the supervisor reinforcement learning agent, wᵢ represents an output of the i-th reinforcement learning agent, and N represents a number of adjacent zones.

8. The system of claim 1, wherein the processor is further programmed to generate the simulated environment based on a desired simulated driving situation.

9. A system comprising a computer including a processor and a memory, the memory including instructions such that the processor is programmed to:
receive collected vehicle state parameters from a vehicle;
determine whether a reported problem corresponding to the collected vehicle state parameters are below a predetermined frequency threshold; and
retrain at least one reinforcement learning agent within a constructed simulated driving scenario based on the collected vehicle state parameters.

10. The system as recited in claim 9, wherein the processor is further programmed to determine whether the reported problem affects a number of vehicles that exceeds a predetermined vehicle amount.

11. The system as recited in claim 10, wherein the processor is further programmed to generate an alert when the reported problem affects a number of vehicles that exceeds the predetermined vehicle amount.

12. The system as recited in claim 11, wherein the alert comprises at least one of an audio alert, a haptic alert, or a visual alert.

13. A method comprising:
generating a simulated environment, the simulated environment representing a plurality of driving situations; and
generating, via a reinforcement learning agent, at least one calibration parameter based on simulated vehicle operations within a simulated environment.

14. The method of claim 13, the method further comprising generating reinforcement learning agent for each zone within an operation state space, wherein each zone corresponds to a set of calibration parameters.

15. The method of claim 14, the method further comprising dividing the operation state space into at least two adjacent operation state space zones when the reinforcement learning agent has not converged.

16. The method of claim 15, wherein each reinforcement learning agent trains for at least one of a predetermined computation budget or a predetermined time budget.

17. The method of claim 15, the method further comprising generating a supervisor reinforcement learning agent that is configured to manage transitions between at least two adjacent operation state space zones.

18. The method of claim 17, wherein the supervisor reinforcement learning agent generates a transition set of calibration parameters based on the adjacent zones.

19. The method of claim 18, wherein the supervisor reinforcement learning agent generates the transition calibration parameter according to w=a₁w₁+a₂w₂+ . . . a_{N}w_{N}, where aᵢ represents an i-th coefficient generated by the supervisor reinforcement learning agent, wᵢ represents an output of the i-th reinforcement learning agent, and N represents a number of adjacent zones.

20. The method of claim 13, the method further comprising generating the simulated environment based on a desired simulated driving situation.
